(19) United States
(12) Patent Application Publication
(10) Pub. No.: US 2012/0221546 A1
(43) Pub. Date: Aug. 30, 2012

(54) METHOD AND SYSTEM FOR FACILITATING WEB CONTENT AGGREGATION INITIATED BY A CLIENT OR SERVER

(76) Inventors: Lawrence C. Rafsky, Livingston, NJ (US); Robert E. Ungar, Randolph, NJ (US); Thomas B. Donchez, Bethlehem, PA (US); Jonathan A. Marshall, Montclair, NJ (US)

(21) Appl. No.: 13/403,376

(22) Filed: Feb. 23, 2012

Related U.S. Application Data
(60) Provisional application No. 61/446,085, filed on Feb. 24, 2011.

(51) Int. Cl. G06F 17/30

(52) U.S. Cl. 707/709; 707/E17.108

(57) ABSTRACT

A method for facilitating Web content aggregation initiated by a client is disclosed. A Web site aggregation list is created. At least one Web site in the aggregation list is spidered from a user-identified computer. At least one attribute of content of the at least one spidered Web site is merged with at least one attribute of content of another Web site. The merged attributes are displayed to a user.

### CROSS-REFERENCE TO RELATED APPLICATION

This application claims the benefit of U.S. provisional patent application No. 61/446,085 filed Feb. 24, 2011, the disclosure of which is incorporated herein by reference in its entirety.

### FIELD OF THE INVENTION

The present invention relates generally to a method and system for Web content aggregation. More specifically, the present invention relates to providing a mechanism for individual client or server machines to aggregate Web content.

### BACKGROUND OF THE INVENTION

Many businesses gather Web site content through a technology called spidering, which involves using automated software, often called a Web spider or Web crawler, to methodically download content of Web sites. Through spidering, business may aggregate content from multiple sources on the Web into one collection. After spidering, software may extract, gather, or create attributes related to the aggregated content, including, but not limited to, a headline, summary, content indexes, categories, and a Web hyperlink, which points to the original source of the spidered content. These attributes may be used by the business for distribution or posting on a Web site for their readers or subscribers to read in one location.

However, some Web sites do not permit automated crawlers directed by aggregation businesses to spider their Web sites. This means that subscribers to the aggregation business cannot read content from these non-allowed Web sites in the single location or distribution offered to them by the aggregation business. These non-allowed Web sites may permit individual users, and therefore the individual subscribers of the aggregation business, to visit and to spider their sites.

Accordingly, what would be desirable, but has not yet been provided, is a mechanism to permit individual subscribers to spider selected Web sites and to seamlessly merge attributes of content spidered from the Web sites with the aid an aggregation service.

### SUMMARY OF THE INVENTION

Embodiments of the present invention are directed to a method and system configured to permit seamless integration of individual user-spidered Web site content with aggregated spidered Web site content distributed by Web aggregation businesses, herein referred to as a “Web Personal Access Site Selection” method/system or “Web PASS.” Web PASS is a method/system configured to permit individual users to efficiently aggregate Web content. Advantageously, Web PASS permits the user to view headlines, summaries, and hyperlinks from Web sites of their choice, seamlessly merged with the headlines, summaries, and hyperlinks from one or more Web content aggregators.

The above-described problems are addressed and a technical solution achieved by providing a method for facilitating Web content aggregation initiated by a client. A Web site aggregation list is created. At least one Web site in the aggregation list is spidered from a user-identified computer. At least one attribute of content of the at least one spidered Web site is merged with at least one attribute of content of another Web site. The merged attributes are displayed to a user.

In an embodiment, the aggregation list may include at least one URL associated with the at least one Web site. In an embodiment, the user may be permitted to view original Web site content associated with the merged attributes. The content of the at least one spidered Web site may be filtered to obtain the at least one attribute of content of the at least one spidered Web site. Filtering the content of the at least one spidered Web site may comprise applying a de-chrome script to the content of the at least one spidered Web site. The aggregation list may store a recommended time and update frequency for re-spidering the at least one Web site.

In an embodiment, the method may further comprise running a search for updates to Web sites in the aggregation list in the background and notifying the user when new or updated content is available. A hash of content of the at least one spidered Web site may be created to create a unique string representing the spidered content. The hash of content of the at least one spidered Web site may be compared to a hash of the content of the at least one spidered Web site from another user-identified computer or server and re-spidering the at least one Web site if the comparison does not match. The at least one attribute of content of the at least one spidered Web site may be merged with streaming news content. Content updates from Web sites listed in an aggregation list of a server may be requested. The method may further comprise uploading a notification to the server that content has been downloaded, searching the server to obtain new content from another client, and downloading the new content from the another client.

In an embodiment, the content that has been download from the server and the new content from another client may be in a hashed format.

The above-described problems are addressed and a technical solution achieved by providing a method for facilitating Web content aggregation initiated by a server. A plurality of Web site aggregation lists may be received from a plurality of user-identified computers. The plurality of Web site aggregation lists is merged into a global aggregation list. At least one Web site is spidered in the global aggregation list. At least one attribute of content of the at least one spidered Web site is merged with at least one attribute of content of another Web site. The merged at least one attribute of content is transmitted to at least one of the plurality of user-identified computers.

In an embodiment, each of the plurality of the Web site aggregation lists in the global aggregation list may be associated with a corresponding at least one profile of a user-identified computer. The at least one profile of a user-identified computer may be a plurality of profiles for a user, and wherein a user-identified computer has multiple display mechanisms for different profiles.

In an embodiment, the server may notify a client that new content is available.

### BRIEF DESCRIPTION OF THE DRAWINGS

The present invention may be more readily understood from the detailed description of an exemplary embodiment presented below considered in conjunction with the attached drawings and in which like reference numerals refer to similar elements and in which:

FIG. 1 is a block diagram of one embodiment of a system for facilitating Web content aggregation initiated by a user;

FIG. 2 illustrates a diagrammatic representation of a machine in the exemplary form of a computer system within which a set of instructions, for causing the machine to perform any one or more of the methodologies discussed herein, may be executed;

FIG. 3 depicts one embodiment of software architectural elements that may be divided between a server, a plurality of clients, and a plurality of the Web sites interconnected over the Internet;

FIG. 4 is a flow diagram illustrating one embodiment of a method for facilitating Web content aggregation initiated by a user;

FIG. 5 illustrates one embodiment of a client-side aggregation list;

FIG. 6 depicts one embodiment of a content scrolling user interface as associated with a Web PASS client application;

FIG. 7 depicts an exemplary content window of a Web site;

FIG. 8 depicts one embodiment of spidered content merged with streamed news;

FIG. 9 is a flow diagram illustrating one embodiment of a method for facilitating Web content aggregation initiated by a server; and

FIG. 10 illustrates one embodiment of a server-side global aggregation list.

It is to be understood that the attached drawings are for purposes of illustrating the concepts of the invention and may not be to scale.

### DETAILED DESCRIPTION OF THE INVENTION

The present invention provides a method and system for individual client or server machines to aggregate Web content. The method employs an external third-party Web aggregation service augmented with additional aggregation that the client directs and runs locally. The method further synchronizes Web content filter criteria between the third-party Web aggregation service and a client's local aggregation, coordinates Web content sources with other clients, and shares the spidering workload with other clients, thereby distributing the effort involved.

According to an embodiment, the above described steps are part of a computer program, application, computer-executable instructions, or software package that runs on an end user's computer, herein referred to as the ‘client’ or ‘client program’. The client program may be used by an individual user, and spidering runs on the user's computer.

As used herein, the term “program”, “application”, “software package” or “computer executable instructions” refers to instructions that may be performed by a processor and/or other suitable components. The term “computer” or “server”, as used herein, is not limited to any one particular type of hardware device, but may be any data processing device such as a desktop computer, a laptop computer, a kiosk terminal, a personal digital assistant (PDA) or any equivalents or combinations thereof. Any device or part of a device configured to process, manage or transmit data, whether implemented with electrical, magnetic, optical, biological components or otherwise, may be made suitable for implementing the invention described herein.

As used herein, the term “communicatively connected” is intended to include any type of connection, whether wired or wireless, in which data may be communicated. Furthermore, the term “communicatively connected” is intended to include a connection between devices and/or programs within a single computer or between devices and/or programs on separate computers.

Although specific embodiments have been illustrated and described herein, those of ordinary skill in the art will appreciate that an arrangement configured to achieve the same results may be substituted for the specific embodiments shown. This disclosure is intended to cover adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used.

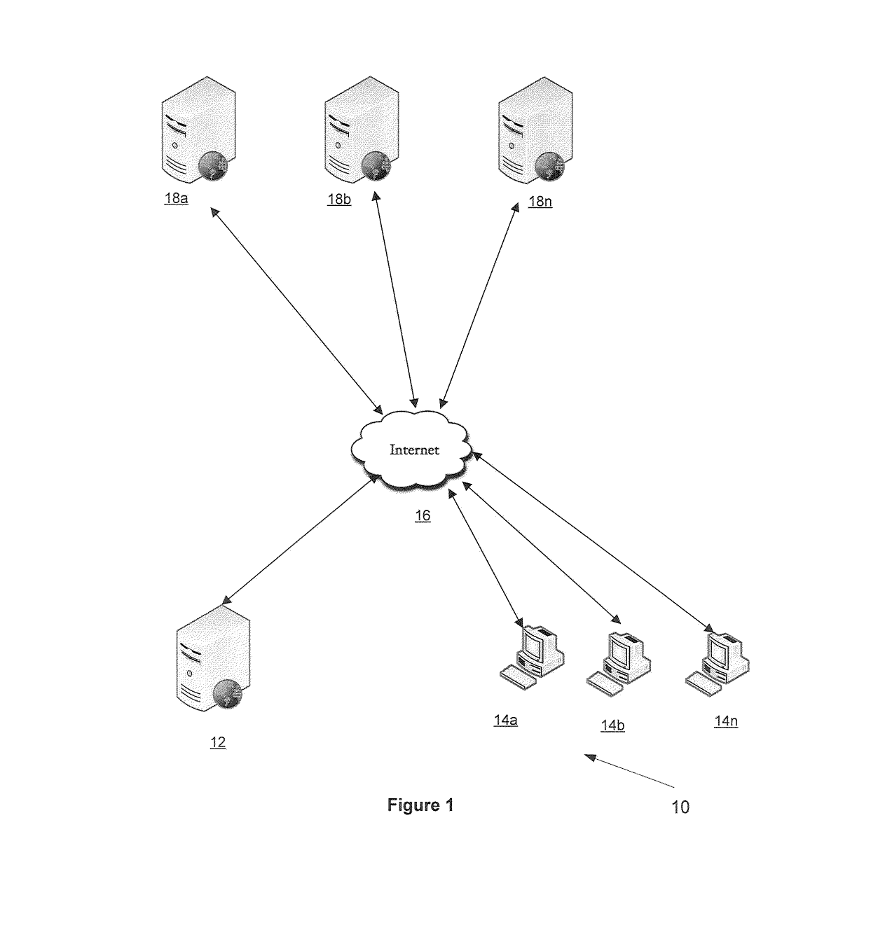

FIG. 1 is a block diagram of one embodiment of a system for facilitating Web content aggregation initiated by a client. The system 10 includes a server machine 12 (hereinafter “the server 12”) hosting a server-side application program for executing a server-side Web PASS method. The server 12 communicates with a plurality of user-identified machines 14a-14n (hereinafter, the “clients 14a-14n”), each machine hosting a client-side application program for executing a client-side Web PASS method over a network 16, which may be the Internet 16. The server 12 and the clients 14a-14n are communicatively connected, e.g., over the Internet 16 to a plurality of machines 18a-18n, each hosting a Web server program (hereinafter the “Web sites 18a-18n”).

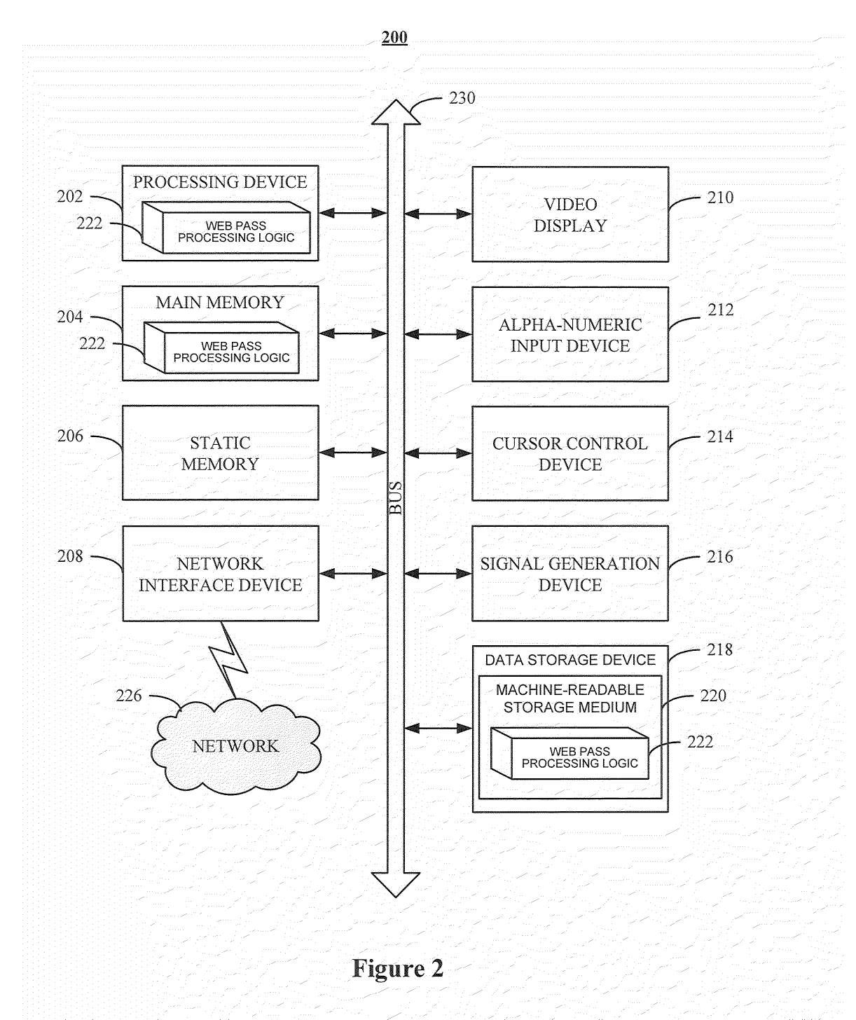

FIG. 2 illustrates a diagrammatic representation of a machine in the exemplary form of a computer system 200 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment (i.e., the server 12 and/or the clients 14a-14n), or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 200 includes a processing device 202, a main memory 204 (e.g., read-only memory (ROM), flash memory, dynamic random access memory (DRAM) (such as synchronous DRAM (SDRAM) or Rambus DRAM (RDRAM), etc.)), a static memory 206 (e.g., flash memory, static random access memory (SRAM), etc.), and a data storage device 218, which communicate with each other via a bus 230.

Processing device 202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 202 may also be one or more special-purpose processing devices such as an application specific integrated circuit (ASIC), a field programmable gate array (FPGA), a digital signal processor (DSP), network processor, or the like. Processing device 202 is configured to execute device queue manager logic 222 for performing the operations and steps discussed herein.

Computer system 200 may further include a network interface device 208. Computer system 200 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

Data storage device 218 may include a machine-readable storage medium (or more specifically a computer-readable storage medium) 220 having one or more sets of instructions (e.g., Web PASS processing logic 222) embodying any one or more of the methodologies of functions described herein. Web PASS processing logic 222 may also reside, completely or at least partially, within main memory 204 and/or within processing device 202 during execution thereof by computer system 200; main memory 204 and processing device 202 also constituting machine-readable storage media. Web PASS processing logic 222 may further be transmitted or received over a network 226 via network interface device 208.

Machine-readable storage medium 220 may also be used to store the device queue manager logic persistently. While machine-readable storage medium 220 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein may be implemented as discrete hardware components or integrated in the functionality of hardware components such as ASICs, FPGAs, DSPs or similar devices. In addition, these components may be implemented as firmware or functional circuitry within hardware devices. Further, these components may be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

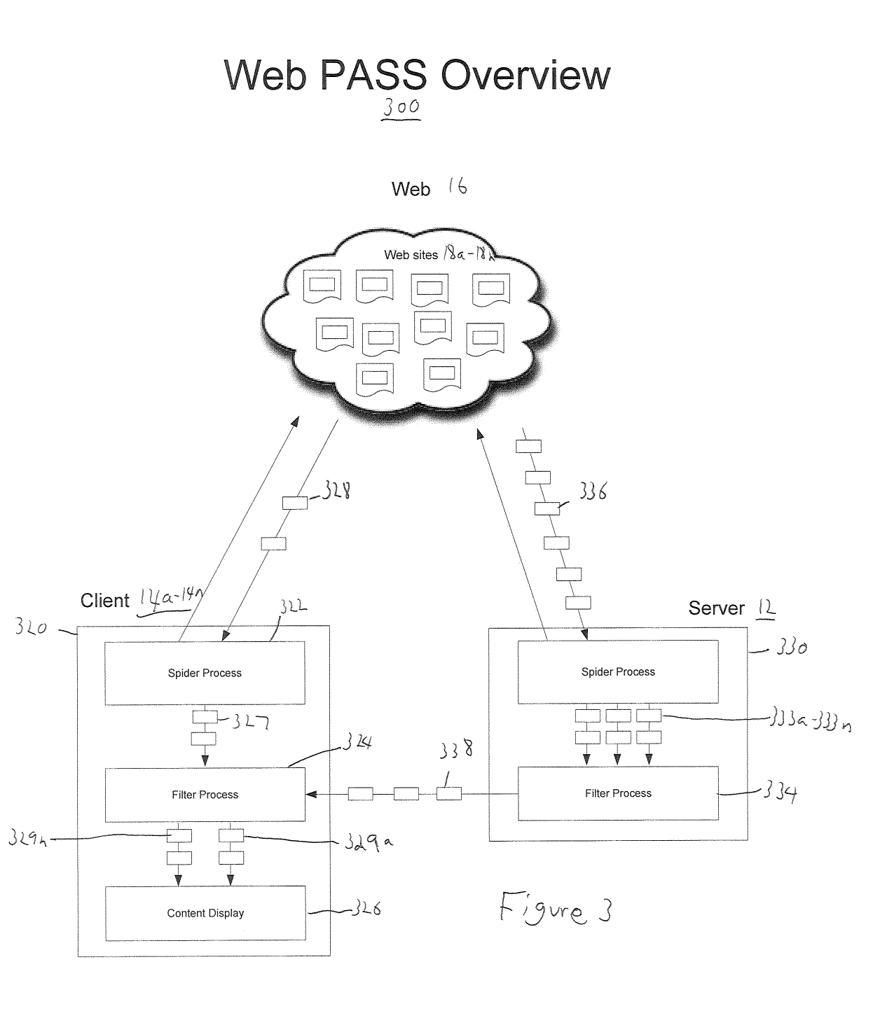

FIG. 3 depicts one embodiment of software architectural elements 300 that may be divided between the server 12, the plurality of the clients 14a-14n, and a plurality of the Web sites 18 interconnected over the Internet 16. Each of the clients 14a-14n may include a Web PASS client-side application 320, which may include a spider process 322 for spidering content 328 from one or more of the Web sites 18 employing aggregation lists to be described below. The spidered content 327 may be filtered by a filtering process 324 to extract or create one or more attributes 329a-329n from the one or more Web sites 18a-18n and then formatting and displaying the combined attributes 329a-329n on the display (not shown) of the client 14a-14n by employing a content display process 326.

The server 12 includes a server-side application 330 configured to spider one or more of the Web sites using a spidering process 332. The spidered content 336 may be filtered by a filtering process 334 to extract or create one or more attributes 333a-333n from the one or more Web sites 18 and then optionally forwarding the filtered attributes 338 to the display process 326 of the clients 14a-14n.

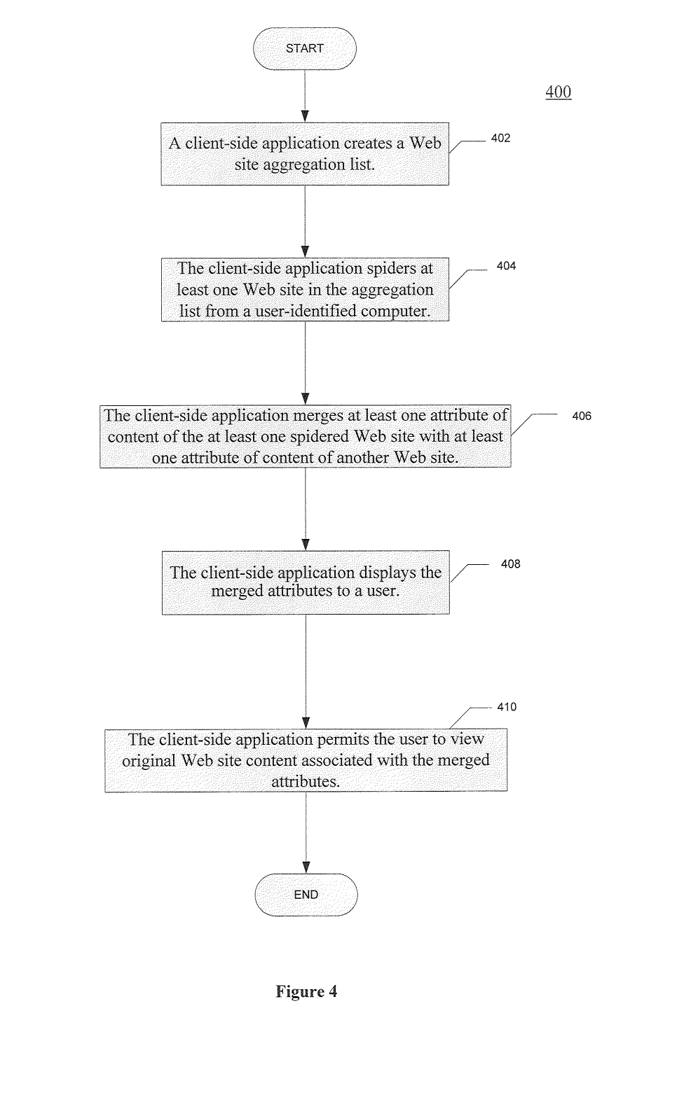

FIG. 4 is a flow diagram illustrating one embodiment of a method 400 for facilitating Web content aggregation initiated by a client 14a-14n. Method 400 may be performed by Web PASS processing logic (e.g., in computer system 200 of FIG. 2) that may comprise hardware (e.g., circuitry, dedicated logic, programmable logic, microcode, etc.), software (such as instructions run on a processing device), firmware, or a combination thereof.

At block 402, the client-side application 320 may create at least one Web site aggregation list, each containing at least one (URL of a) Web site 18a-18n. At block 404, the client module 320 may spider content 36 from the Web sites 18a-18b in the aggregation list over the Internet 16 using the spider process 322 from a user-controlled or user-owned computer. At block 406, the client-side application 320 may filter the spidered content 327 and merge extracted or created attributes 329a-329n of the spidered Web sites 16a-16n with the attributes 329a-329n of the content of other Web sites 16a-16n. At block 408, the client-side application 320 may display the merged attributes 329a-329n to the user using the content display process 326. At block 410, the client-side application 320 may permit the user to view the original Web site content associated with the merged attributes 329a-329n.

Aggregation List

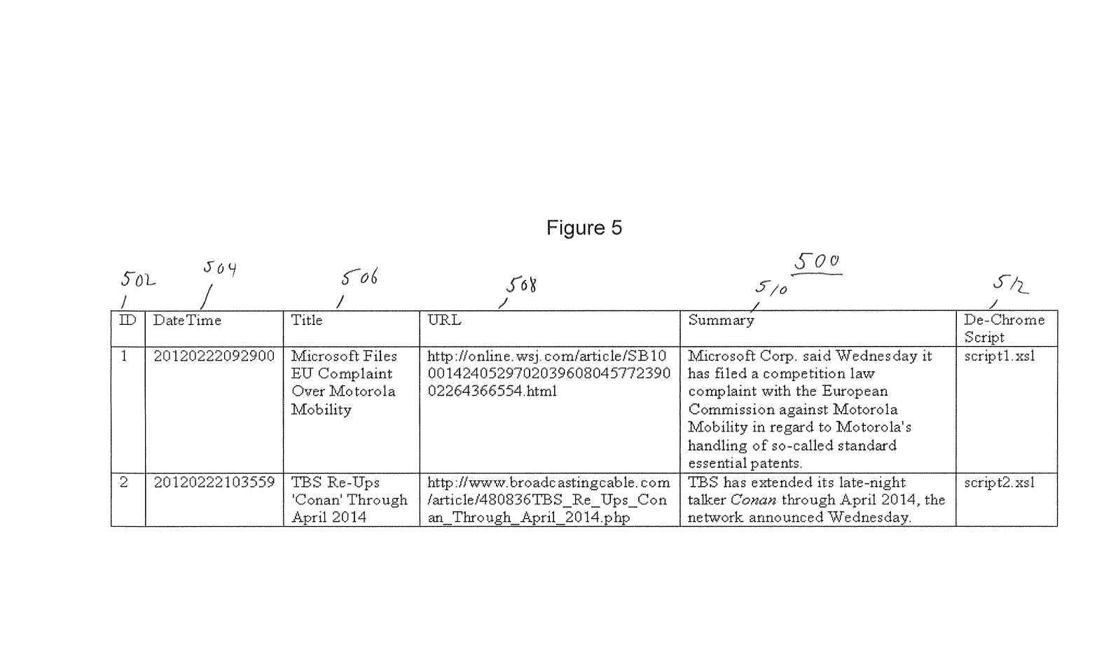

FIG. 5 illustrates one embodiment of a client-side aggregation list 500. The aggregation list 500 is a user generated list of the Web sites 18a-18n for spidering content and updates to content as well as RSS and blog sources. This aggregation list 500 may comprise, but is not limited to, an identifier (ID) 502, a time stanp 504, a title of content of the Web site 506, a public Web site address 508, or URL, where content is displayed. The aggregation list 500 may also include ancillary information, such as a description of content of the Web site 510, and a text-isolation or “de-chrome” script 512 for the site. A de-chrome script, as is known in the art, is a computer program that removes advertisement, menu, navigation, and markup content from the spidered content, leaving the desired, substantive content. De-chrome scripts may be similar between Web sites, but they are often customized for the Web site being crawled.

Items in the aggregation list 500 may be stored in a database table or a system file. The attributes gathered from each of the Web sites 18a-18n may be stored in an individual file, permitting them to be shared and distributed, or all of attributes gathered from each of the Web sites 18a-18n may be listed in one file. The file may be formatted as, but not limited to, an XML style file or a key/value pair file.

A default or recommended aggregation list may be provided to new Web PASS users, and users may add new Web sites to the list or download them from a server library through the client-side application 320. Users may also add a custom de-chrome script, choose from the default, or browse a library of de-chrome scripts to associate with the Web site 18a-18n. The new Web site 18a-18n may be added as a spider source or RSS feed in the client-side application 320.

Cooperative Aggregation List

The aggregation list 500 may be stored on the client 14a-14n or in shared library on a server 12. The aggregation list 500 of Web sites 18a-18n, which may include URLs and optional ancillary information such as de-chrome scripts, may be stored on the server 12 accessible by the multiple clients 14a-14n. Web sites 18a-18n may be listed on a server 12 as a service for profit or non-profit. Users of Web PASS may upload their own aggregation lists 500 of the Web sites 18a-18n and scripts or download them from the server 12, encouraging sharing and cooperation among users.

Cooperative Aggregation Time Strategies

The aggregation list 500 may also store a recommended time and update frequency of each of the Web Sites 18a-18n. This permits the client 14a-14n to be aware of when new or updated content is likely to become available on the Web sites 18a-18n, and thereby reduce the number of spider requests. A user may be a frequent visitor to, or even the creator of, a Web site in an aggregation list 500 and provide updates to the content update frequency or time. Users may see a last-modified date or time stamp 504 to determine whether a Web site source-check frequency attribute is too high or too low, and may adjust it accordingly. For blogs, blog-ping servers may be integrated to determine appropriate content request times.

The server or client applications 230, 220, respectively, may also include a mechanism for determining if links are valid, and notify users if a Web site 18a-18n becomes unavailable.

Web PASS Client Software

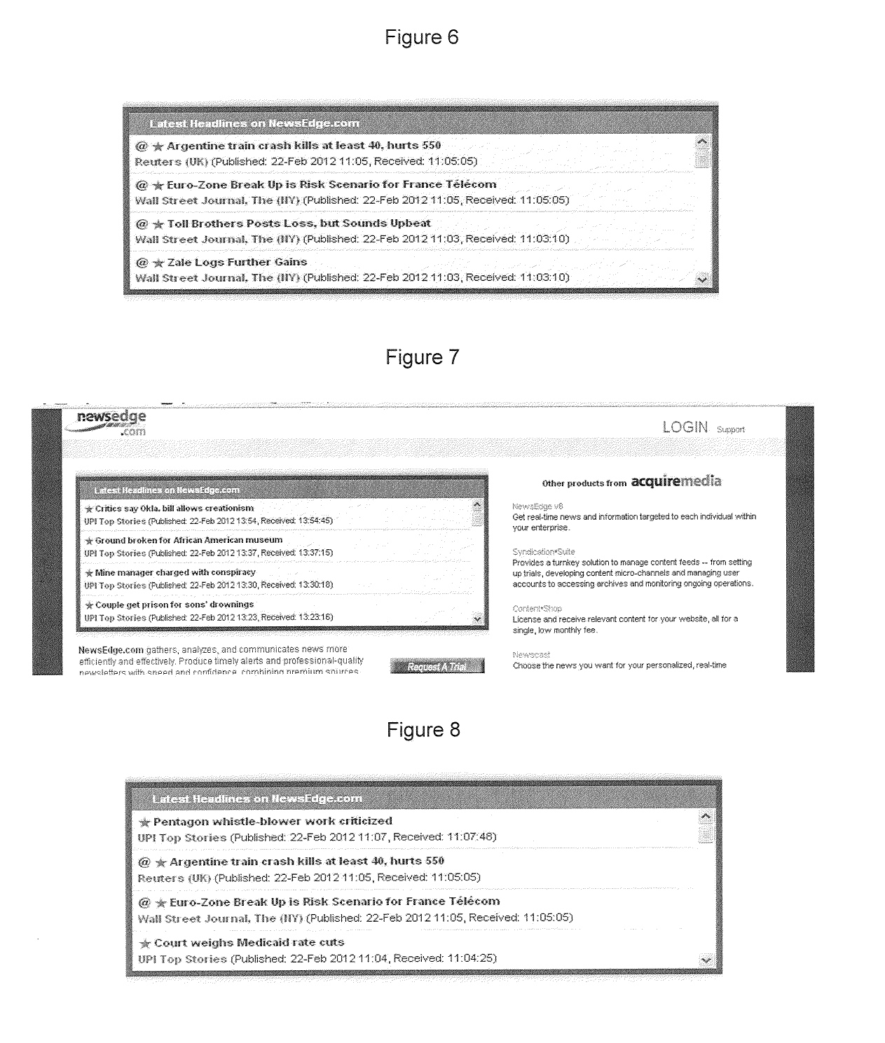

The Web PASS client application 220 may include an RSS reader, a desktop/client based web spider, a content parser, a content filtering engine, and a content display mechanism, such as, but not limited to, a content scrolling user interface as depicted in FIG. 6. The Web PASS client-side application 320 may include a program developed to run on any operating system, including, but not limited to Windows, Mac OS, or Linux. The Web PASS client-side application 320 in its most basic form provides a list of content found on each of the Web sites 18a-18n, which may be sorted by latest updates first, or may be sorted by aggregate source or any other attribute. The Web PASS client-side application 320 may be implemented as a stand alone streaming content client on a desktop or mobile environment or a Web application, as well as a plug in or extension to a Web browser, such as, but not limited to Microsoft Internet Explorer®, Mozilla Firefox®, or Google Chrome™.

The content display process 326 of the client-side application 320 includes content received from spidering and the RSS reader. Attributes from multiple Web sites 18a-18n may be merged together in the content display process 326 or may appear in different windows or other interfaces containing a content display process 326. The filter process 324 of the client-side application 320 permits the suppression of content that does, or does not, contain a set of key words and phrases, or content that does not pass a natural-language-based Boolean filter, using AND, OR, NOT, PROXIMITY, NEAR, and SIGNIFICANT-MENTION operators, and groupings, along with content zones such as title, first paragraph, first 10 sentences, first 1000 words, second paragraph, second 5 sentences, second-through-fifth paragraph, etc., in any combination, and/or zones pertaining to XML or HTML tags present in the content. The filter process 324 of the client-side application 320 may run the same filters that are run on the user's behalf by an aggregation service, and the two sets of filters may be kept updated at all times without manual user-maintenance tasks, via automated synchronization.

Clicking on or near a content item in the content display filter process 324 of the client-side application 320 directs the user to the Web site 18a-18n where the content originated to view the original source or an approved third-party aggregator with the appropriate licenses. The content may open in a new window in the client-side application 320 or open a Web browser program such as Microsoft Internet Explorer®, Mozilla Firefox®, or Google Chrome™ to view the source Web site as depicted in FIG. 7.

The software also may be configured as a content parser in that it runs the associated de-chrome script against Web content to remove advertisements, menu, navigation, and other parts of the content to obtain the content of interest.

Update Notification

An embodiment of the client-side application 320 may run searches for updates to Web sites 18a-18n in the aggregation list 500 in the background and then notify the user when new or updated content is available. In a standalone application, a list of content sources (i.e., the Web sites 18a-18n) may be visible to the user; when new content is available from a particular source, the content display process 326 may notify the user of the new content by an alert mechanism related to the source, such as a notification column, a pop-up notice, a sound, or a blinking mechanism. The user then clicks on or otherwise interacts with the content source title to view new content. In a Web browser plug-in, a notification icon in the control bar may notify the user of new content. A clickable button may allow the user to redirect to a generated local Web page displaying the content or content attributes.

Hashing

Another variation on the above described technique includes hashing, a technique known in the art for transforming a string of characters into a compressed value representing the original string. The content spidered by the client-side application 320 may be hashed to create a unique string representing the spidered content. This hash may be used to coordinate updates to the content among the client applications 320 or the clients 14a-14n and the server 12.

In one embodiment, a client 14a-14n may hash any new content downloaded on a Web site 18a-18n. The hash record may be transmitted to other clients 14a-18n using the Web PASS client-side application 320, along with a source ID or URL and a content or download time. The clients 14a-14n that receive the hash may compare the hash to their own hash of the latest content they received, along with the source ID, URL, and/or time to determine whether they have the new content. If a first client's last hash of a source does not match that of another client, then the first client may spider or request the RSS feed of the source to get the latest content.

In another implementation using hashing, the clients 14a-14n may hash downloaded content and upload it to the server 12, including source information and download time. Each client 14a-14n periodically checks the server 12 for new hashes for each source, and if a new hash is found on the server 12 that is not in the client's local storage, the client 14a-14n may then download the content from the source Web site 18a-18n.

In another implementation using hashing, the server 12 may spider content and create hashes of the content to store on the server 12. The clients 14a-14n then periodically check the server 12 for new hashes by comparing them to their local aggregation list 500, and then spider or request the RSS feed of sources for which a new hash is present on the server 12.

One benefit of hashing is that the spidered content itself, which may be voluminous or copyrighted, is not transmitted or copied. Instead, it is the hash that is transmitted or copied. Furthermore, hash values may be made secure through well-known encryption techniques, permitting users to share and trust hash values with confidence (i.e., they are tamper proof, and authenticated).

Streaming News Integration

Another variation of the software may integrate with news streaming software, either a client-side or Web application. In such circumstances, the aggregated content may appear merged among the existing streaming news, or the aggregated news may appear in a separate window as shown in FIG. 8. The aggregation software may also run in a different process than the streaming news software and communicate via Inter-Process Communication (IPC).

By integrating with streaming news, the spider process 322 may be more refined and filter content to insure it relates to the topics of news articles in the streaming news. For instance, if a press release arrives about IBM's earnings at 3:00, the spider process 322 may aggregate content on the user's aggregation list Web sites and filter between 3:00 and 3:30 for any articles related to this particular earnings release (i.e., by using keywords and phrases contained in the release). The aggregated content attributes may appear merged among the streaming news, or as a separate content display, possibly with related streaming news attributes, if displayed in a separate window or process. One main advantage of this approach is that users do not need to explicitly specify filters, nor keep them in sync with the filter process 324 of the aggregation list 500 as discussed above. The content of the streaming news is used to automatically construct filters for spidered Web content on-the-fly, essentially implementing a “get me more content like the news I am getting in my stream” operation.

When using update notification with streaming news integration, updates found from the spider process 322 related to a single streaming news source may appear as a notification, as described above.

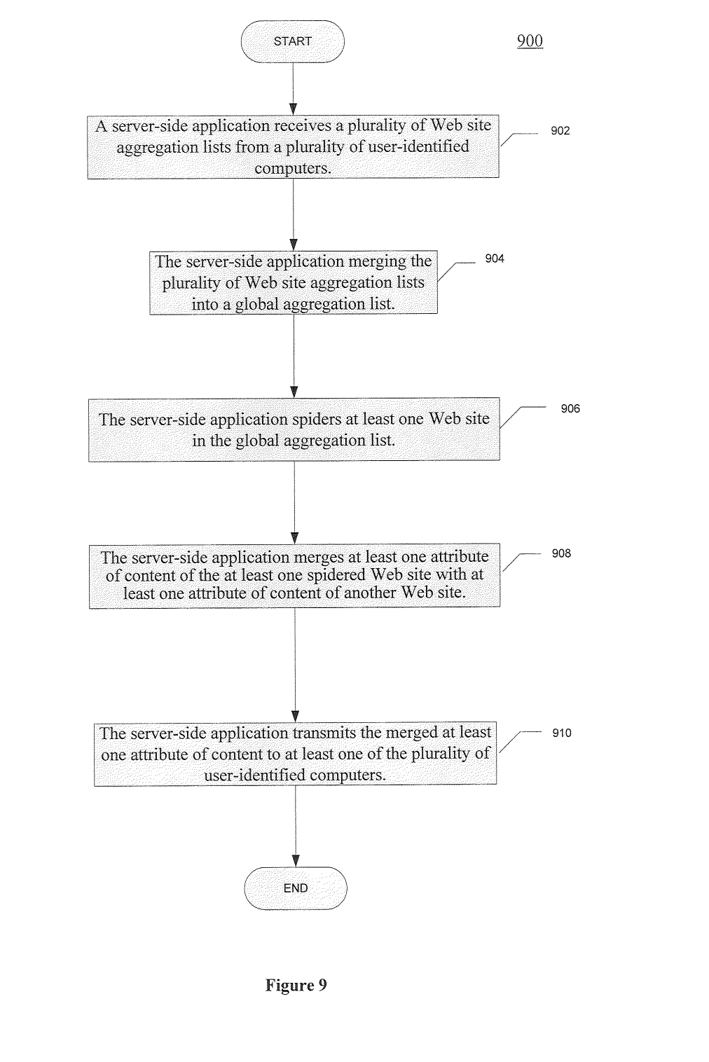

FIG. 9 is a flow diagram illustrating one embodiment of a method 900 for facilitating Web content aggregation initiated by a server. Method 900 may be performed by Web PASS processing logic (e.g., in computer system 200 of FIG. 2) that may comprise hardware (e.g., circuitry, dedicated logic, programmable logic, microcode, etc.), software (such as instructions run on a processing device), firmware, or a combination thereof.

At block 902, the server-side application 330 receives a plurality of Web site aggregation lists 500 from a plurality of user-identified computers. At block 904, the server-side application 330 merges the plurality of Web site aggregation lists 500 into a global aggregation list. At block 906, the server-side application 330 spiders at least one Web site 18a-18n in the global aggregation list using the spidering process 332. At block 908, the server-side application 330 merges at least one attribute of spidered content 336 of the at least one spidered Web site 18a-18n with at least one attribute of spidered content 336 of another Web site 18a-18n using the filtering process 334 of the server-side application 330. At block 910, the server-side application 330 transmits the merged attributes of content 333a-333n to at least one of the plurality of user-identified computers (i.e., the clients 14a-14n).

Server Aggregation

In another embodiment, some spidering and content aggregation may occur on a server 12 to reduce the overall number of Web requests sent to the Web sites 18a-18n. The server 12 spiders some or all of the Web sources subscribed to Web PASS, and/or many additional Web sources and indexes spidered content. The client-side application 320, either a stand alone program or integrated with a streaming news client or Web browser, requests content updates from Web sites 18a-18n listed in its aggregation list 500.

In another implementation of a shared server 12, the server 12 has a profile of each Web PASS user containing its aggregation list 500. The server 12 then associates Web content updates to each spidered content source or RSS feed to a user. The server 12 may then notify the connected client 14a-14n that new content is available. The client 14a-14n may then query for updates to the Web sites 18a-18n in its aggregation list 500, or the server 12 may send the content to the client for streaming.

Shared Server Aggregation

The level of server involvement may depend on the Web source's preferences and permissions, which indicate whether the server 12 may aggregate and index content (i.e., in the view of the Web sites 18a-18n). For restricted content, the users may themselves perform the spidering and aggregation from the aggregation list 500. The server 12 in this way avoids failing to honor the requests or demands of the Web site 18a-18n with regards to that content.

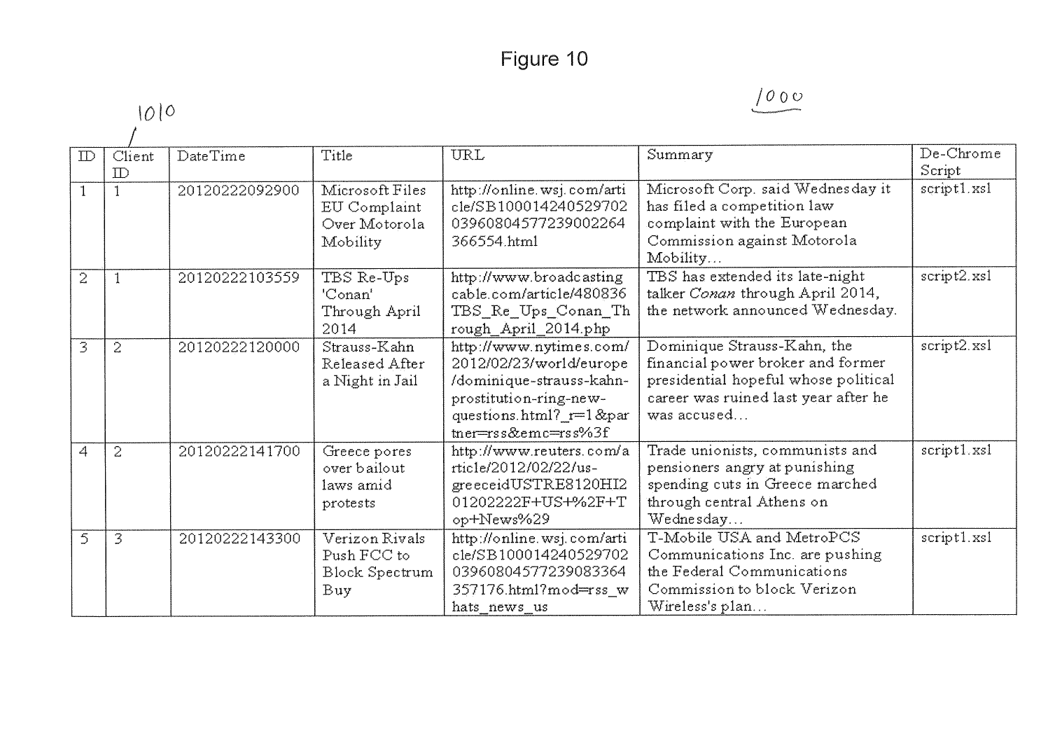

In another implementation, the server 12 may be used to aggregate Web content for the Web sites 18a-18n in a global server side aggregation list 1000 as depicted in FIG. 10, and the client may aggregate some content from its local aggregation list 500. In one embodiment, the fields of the global aggregation list may be substantially the same as those of the aggregation list 500, except for the addition of a client identifier (client ID) 1010. The server 12 may contain a profile of users and receive search filters, such as “Canadian Newspapers.” The server 12 may provide a list of Web content sources available fitting this description, and which sources it may stream news to the client 14a-14n and which sources the client 14a-14n needs to aggregate due to restrictions or technical issues. The user also has the option of including filter terms in their profile, where the sources are filtered for key words. Filters may include natural-language-based Boolean filters, using AND, OR, NOT, PROXIMITY, NEAR, and SIGNIFICANT-MENTION operators, and groupings, along with content zones such as title, first paragraph, first 10 sentences, first 1000 words, second paragraph, second 5 sentences, second-through-fifth paragraph, etc. in any combination, and/or zones pertaining to XML or HTML tags present in the content, which are used to match content to the filter. Multiple profiles may be created for a user, and the client-side application 320 may have multiple display mechanisms for different profiles, or they may be combined into one display window.

Peer-to-Peer Content Aggregation

In another embodiment, in a less centralized solution, the clients 14a-14n may download RSS and spider content and upload a notification to the server 12 that the clients 14a-14n have downloaded content. Each of the clients 14a-14n may also search the server 12 to see if new content is available from other clients 14a-14n. The client 14a may then download available content listed on the server 12 from the client 14n that posted the content. When a second client 14b obtains the content, it informs the server 12 that the second client 14b may also be a source. Other clients 14a-14n may then download from both sources, creating a Peer-to-Peer sharing environment. This method reduces the number of requests to the Web sites 18a-18n and improves the likelihood of each client 14a-14n obtaining new content in between its own individual aggregation requests to the original Web content. According to an embodiment of the present invention, this same technique may be used with hash values instead of content.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but may be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A computer-implemented method for facilitating Web content aggregation initiated by a client, comprising the steps of:
creating a Web site aggregation list;
spidering at least one Web site in the aggregation list from a user-identified computer;
merging at least one attribute of content of the at least one spidered Web site with at least one attribute of content of another Web site; and
displaying the merged attributes to a user.

2. The method of claim 1, wherein the aggregation list includes at least one URL associated with the at least one Web site.

3. The method of claim 1, further comprising permitting the user to view original Web site content associated with the merged attributes.

4. The method of claim 1, further comprising filtering the content of the at least one spidered Web site to obtain the at least one attribute of content of the at least one spidered Web site.

5. The method of claim 4, wherein filtering the content of the at least one spidered Web site comprises applying a de-chrome script to the content of the at least one spidered Web site.

6. The method of claim 5, wherein filtering the content of the at least one spidered Web site further comprises suppressing content that does, or does not, contain a set of key words and phrases, or content that does not pass a natural-language-based Boolean filter, along with content zones such as title, first paragraph, first 10 sentences, first 1000 words, second paragraph, second 5 sentences, second-through-fifth paragraph, in any combination, and/or zones pertaining to XML or HTML tags present in the content.

7. The method of claim 1, wherein the aggregation list stores a recommended time and update frequency for re-spidering the at least one Web site.

8. The method of claim 1, further comprising:
running a search for updates to Web sites in the aggregation list in the background and
notifying the user when new or updated content is available.

9. The method of claim 1, further comprising creating a hash of content of the at least one spidered Web site to create a compact string representing the spidered content.

10. The method of claim 9, further comprising
comparing the hash of content of the at least one spidered Web site to a hash of the content of the at least one spidered Web site from another user-identified computer or server and
re-spidering the at least one Web site if the comparison does not match.

11. The method of claim 1, further comprising merging the at least one attribute of content of the at least one spidered Web site with streaming news content.

12. The method of claim 1, further comprising requesting content updates from Web sites listed in an aggregation list of a server.

13. The method of claim 12, further comprising:
uploading a notification to the server that content has been downloaded;
searching the server to obtain new content from another client; and
downloading the new content from the another client.

14. The method of claim 13, wherein the content that has been downloaded from the server and the new content from another client is in a hashed format.

15. A non-transitory computer readable storage medium including instructions that, when executed by a processing system, cause the processing system to perform a method comprising:
creating a Web site aggregation list;
spidering at least one Web site in the aggregation list from a user-identified computer;
merging at least one attribute of content of the at least one spidered Web site with at least one attribute of content of another Web site; and
displaying the merged attributes to a user of the user-identified computer.

16. The non-transitory computer readable storage medium of claim 15, wherein the aggregation list includes at least one URL associated with the at least one Web site.

17. The non-transitory computer readable storage medium of claim 15, further comprising permitting the user to view original Web site content associated with the merged attributes.

18. The non-transitory computer readable storage medium of claim 17, further comprising creating a hash of content of the at least one spidered Web site to create a unique string representing the spidered content.

19. A computer-implemented method for facilitating Web content aggregation initiated by a server, comprising the steps of:
receiving a plurality of Web site aggregation lists from a plurality of user-identified computers;
merging the plurality of Web site aggregation lists into a global aggregation list;
spidering at least one Web site in the global aggregation list;
merging at least one attribute of content of the at least one spidered Web site with at least one attribute of content of another Web site; and
transmitting the merged at least one attribute of content to at least one of the plurality of user-identified computers.

20. The method of claim 19, further comprising associating each of the plurality of the Web site aggregation lists in the global aggregation list with a corresponding at least one profile of a user-identified computer.

21. The method of claim 20, wherein the at least one profile of a user-identified computer is a plurality of profiles for a user, and wherein a user-identified computer has multiple display mechanisms for different profiles.

22. The method of claim 19, further comprising, notifying a client that new content is available.
